(19) United States
(12) Patent Application Publication
(10) Pub. No.: US 2010/0302642 A1
(43) Pub. Date: Dec. 2, 2010

(54) OPTICAL ELEMENT AND OPTICAL SYSTEM INCLUDING THE SAME

(75) Inventor: Takehiko Nakai, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/792,344

(22) Filed: Jun. 2, 2010

(30) Foreign Application Priority Data
Jun. 2, 2009 (JP) 2009-132941

(51) Int. Cl. G02B 1/11

(52) U.S. Cl. 359/601

(57) ABSTRACT

Provided is an optical element having a high performance anti-reflection structure without increasing the height of the grating, including: a transparent substrate on which an anti-reflection structure having a plurality of gratings having one of a convex shape and a concave shape are arranged is formed, the plurality of gratings being arranged with an average interval of a wavelength equal to or smaller than a predetermined wavelength falling within a working wavelength range, the anti-reflection structure including a structure wherein a first layer and a second layer having different filling factors of gratings in the arrangement surface of the gratings are laminated, and the first layer and the second layer satisfying a conditional expression of 0.36≦FF1−FF2≦0.56 when the first layer has a filling factor FF1 of the gratings therein and the second layer has a filling factor FF2 of the gratings therein.

### BACKGROUND OF THE INVENTION

1. Field of the Invention

The present invention relates to an optical element and an optical system including the same, in particular, an optical element suitable for use in an optical system of an optical device, such as a digital camera, a video camera, a TV camera, and an observing system.

2. Description of the Related Art

Conventionally, an optical element using glass, a plastic resin, or other transparent material is provided with an anti-reflection coating on a light incident and emerging surface of a transparent substrate so as to reduce surface reflected light. For instance, as the anti-reflection coating for visible light, there is known a multi-layered coating including a plurality of thin dielectric films that are laminated. This multi-layered coating is formed of thin films made of metal oxide or the like that are formed on the transparent substrate by a vacuum evaporation process or the like. As an anti-reflection structure that is used for an optical element, there is known a structure having a region of a plurality of gratings having microscopic asperities at a pitch smaller than a wavelength of the visible light (microscopic asperity structure) formed on a surface of the transparent substrate so as to provide an anti-reflection effect. If a grating having microscopic asperities of a periodical structure having a pitch that is sufficiently smaller than a working wavelength is used, the grating does not generate diffraction, and the grating having microscopic asperities optically works like a thin film having a specific refractive index.

For instance, a case is assumed where a cylindrical grating is formed at a volume ratio 50% of a medium and air on an interfacial surface between the medium of the substrate having a refractive index n2=1.58 and air (n1=1) that is an incident medium. In this case, the grating having microscopic asperities works like a thin film having a refractive index ne=1.29 that is an intermediate value between those of the medium and air. Further, if ne×d is set to be ¼ of the wavelength where d denotes the height of the grating, this grating shape works as an anti-reflection coating. As a method of manufacturing an optical element having the grating with microscopic asperities on the surface, there is known a method in which the microscopic asperity structure is formed on a surface of a mold for molding, and a plastic resin or the like is molded by using the mold (see Japanese Patent Application Laid-Open No. S62-96902 (page 2)). According to this manufacturing method, the anti-reflection structure may be formed at the same time when the optical element is molded. Therefore, unlike a usual anti-reflection coating of a thin film, an additional step of providing the anti-reflection treatment is unnecessary, to thereby facilitate the manufacturing. As a method of forming the microscopic asperity structure on the mold for molding, there are following methods.

A first method includes: forming a resist pattern of the microscopic asperities on the surface of the mold; performing anisotropic etching such as reactive ion etching on the resist pattern; and removing the resist pattern, to thereby form the microscopic asperity shape (see Japanese Patent Application Laid-Open No. 2001-272505 (FIG. 1)). There is also known a method of repeating anodic oxidation porous alumina and etching, to thereby form a pseudo-conical shape on the mold (see Japanese Patent Application Laid-Open No. 2005-156695). Further, there is proposed a method of manufacturing an anti-reflection structure having a random shape grating instead of the above-mentioned grating having a periodical structure, in which nanoparticles are sprayed and coated on a mold so as to form a microscopic asperity structure (see Japanese Patent Application Laid-Open No. 2002-286906).

The microscopic asperity structure may provide a high performance anti-reflection effect relatively easily. However, in order to obtain higher performance anti-reflection characteristic, it is difficult to form the grating shape by molding process. A case where the grating shape is a conical shape is exemplified for description. A pitch P of the grating having microscopic asperities should be set so that the microscopic asperity structure does not generate diffracted light until a specific incident angle is reached in transmission and reflection, considering an application in visible light. Specifically, the pitch P may desirably be equal to or smaller than 200 nm.

On the other hand, it is desirable that the height of the grating having microscopic asperities be ⅕ of the wavelength or larger as much as possible, because smoother change of the refractive index considered to be equivalent thereto may produce higher performance. In order to obtain characteristic of the same or higher level as the anti-reflection coating of the conventional multi-layered coating, it is desirable that the height of the grating is 300 nm or higher. Accordingly, it is preferable that the shape of the microscopic asperity structure has a finer grating pitch P and a larger grating height d for obtaining higher performance anti-reflection characteristic. However, this shape means to be sharper conical shape. For this reason, transferring property and releasing property become difficult in molding process by the mold. In order to obtain higher performance anti-reflection characteristic by using the microscopic asperity structure, the shape of grating becomes difficult to be formed, and hence it is difficult to obtain a grating having ideal microscopic asperities.

### SUMMARY OF THE INVENTION

It is an object of the present invention to provide an optical element having a structure in which a high performance anti-reflection structure is attained with ease by molding or other manufacturing process without increasing the height of the grating having microscopic asperities. Further, it is another object of the present invention to provide an optical system that uses the above-mentioned optical element so as to have good optical performance by reducing undesired diffracted light and occurrence of flare light to minimum.

An optical element according to an aspect of the present invention includes: a transparent substrate; and an anti-reflection structure formed on an interfacial surface between the transparent substrate and an incident medium, in which a plurality of gratings having one of a convex shape and a concave shape are arranged, in which: the plurality of gratings are arranged with an average interval of a wavelength equal to or smaller than a predetermined wavelength falling within a working wavelength range; the anti-reflection structure includes a structure in which a first layer and a second layer are laminated, the first layer and the second layer having different filling factors of gratings in the arrangement surface of the gratings; and the first layer and the second layer satisfy a conditional expression of 0.36≦FF1−FF2≦0.56 when the first layer has a filling factor FF1 of the gratings therein and the second layer has a filling factor FF2 of the gratings therein.

In the optical element described above, the filling factors of the plurality of layers having different filling factors may preferably increase gradually from the incident medium toward the transparent substrate.

Further, in the optical element described above, the first layer and the second layer may preferably satisfy at least one of conditional expressions of:

0.8×λ0/4≦n1e×d1≦1.1×λ0/4; and

0.8×λ0/4≦n2e×d2≦1.1×λ0/4,

when the first layer and the second layer have effective indexes of n1e and n2e, and layer thicknesses of d1 and d2, respectively, and the working wavelength has a central wavelength λ0.

Alternatively, in the optical element described above, the anti-reflection structure may preferably be formed by molding and transferring a shape by using a mold on which an inverted shape of the grating structure of the plurality of gratings is formed.

According to another aspect of the present invention, there may also be provided an image taking optical system which includes the optical element described above.

According to a further aspect of the present invention, there may also be provided an image observing optical system which includes the optical element described above.

According to the present invention, there may be obtained an optical element having a structure in which a high performance anti-reflection structure is attained with ease by molding or other manufacturing process, without increasing the height of the grating having microscopic asperities.

Further features of the present invention will become apparent from the following description of exemplary embodiments with reference to the attached drawings.

### BRIEF DESCRIPTION OF THE DRAWINGS

FIG. 1 is an enlarged perspective view of an optical element having an anti-reflection structure in Example 1 of the present invention.

FIGS. 2A, 2B and 2C are enlarged cross sections of the anti-reflection structure illustrated in FIG. 1.

FIG. 3A is a table illustrating shape parameters of a microscopic asperity structure of Example 1.

FIG. 3B is a graph illustrating a reflectance in the microscopic asperity structure.

FIG. 4A is a table illustrating other shape parameters of the microscopic asperity structure of Example 1.

FIG. 4B is a graph illustrating a reflectance in the microscopic asperity structure.

FIG. 5A is a table illustrating other shape parameters of the microscopic asperity structure.

FIG. 5B is a graph illustrating a reflectance in the microscopic asperity structure.

FIG. 6A is a table illustrating other shape parameters of the microscopic asperity structure of Example 1.

FIG. 6B is a graph illustrating a reflectance in the microscopic asperity structure.

FIG. 7A is a table illustrating other shape parameters of the microscopic asperity structure of Example 1.

FIG. 7B is a graph illustrating a reflectance in the microscopic asperity structure.

FIG. 8 is a graph illustrating a relationship between two layers which have different filling factors and form the microscopic asperity structure according to the present invention.

FIG. 9A is a table illustrating shape parameters of a microscopic asperity structure according to Example 2 of the present invention, in which a resin material is used.

FIG. 9B is a graph illustrating a reflectance in the microscopic asperity structure.

FIG. 10A is a table illustrating shape parameters of the microscopic asperity structure according to Example of the present invention, in which a high refractive index material is used.

FIG. 10B is a graph illustrating a reflectance in the microscopic asperity structure.

FIG. 11 is an enlarged perspective view of the optical element having an anti-reflection structure according to Example 4 of the present invention.

FIGS. 12A, 12B and 12C are enlarged cross sections of the anti-reflection structure illustrated in FIG. 11.

FIG. 13 is a top view of an element on which microscopic asperity structures according to Example 5 of the present invention are arranged at random.

FIG. 14 is a cross section illustrating another shape of the microscopic asperity structure of the present invention.

FIG. 15A is a table illustrating shape parameters of the microscopic asperity structure having a three-layered structure according to Example 7 of the present invention.

FIG. 15B is a graph illustrating a reflectance in the microscopic asperity structure.

FIG. 16 illustrates an image taking optical system equipped with the optical element of the present invention.

FIG. 17 illustrates an observing optical system equipped with the optical element of the present invention.

### DESCRIPTION OF THE EMBODIMENTS

An optical element of the present invention includes an anti-reflection structure having an anti-reflection function in which a plurality of gratings of a convex shape or a concave shape are arranged on an interfacial surface of a transparent substrate with an incident medium (light incident side). The plurality of gratings are arranged with an average interval of any wavelength or smaller within a working wavelength range (for example, a wavelength range from 400 to 700 nm of visible light). The anti-reflection structure includes a structure in which a first layer and a second layer having different filling factors of the grating in the arrangement surface of the grating are laminated. Here, the number of the laminated layer is not limited to two, and three or more layers may be laminated. The anti-reflection structure of the optical element is formed by using a mold on which an inverted shape of the grating structure of the plurality of gratings is formed so as to mold and transfer the shape.

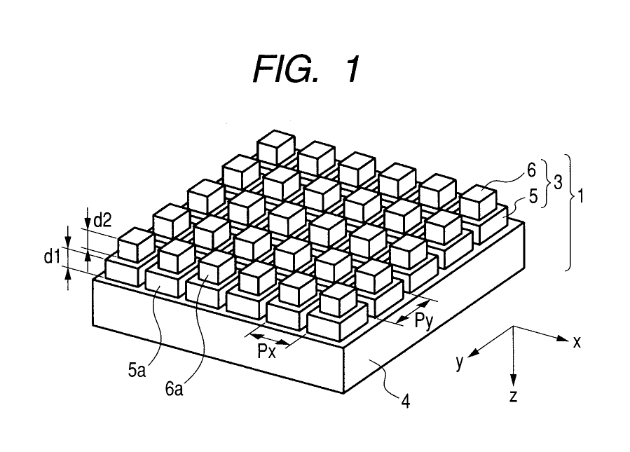

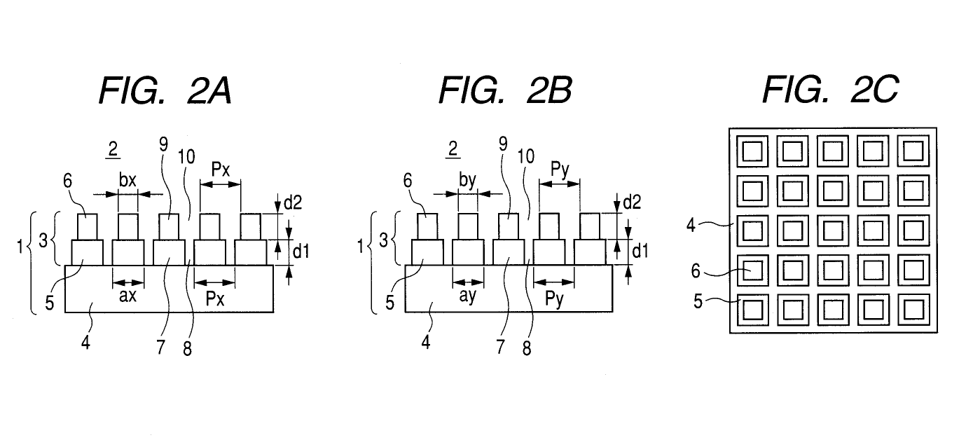

FIG. 1 is a perspective view of a main part of Example 1 of an optical element having the anti-reflection structure which includes a plurality of convex or concave gratings of the microscopic asperity structure according to the present invention. FIGS. 2A, 2B and 2C are explanatory diagrams of the structure of the optical element illustrated in FIG. 1. Among them, FIG. 2A is an explanatory diagram of the xz cross section of FIG. 1, FIG. 2B is an explanatory diagram of the yz cross section of FIG. 1, and FIG. 2C is an explanatory diagram of the xy cross section of FIG. 1. The optical element 1 has a microscopic asperities region (anti-reflection structure) 3 formed on a substrate (transparent substrate) 4. The anti-reflection structure 3 includes a layer (first layer) 5 constituted of a plurality of gratings 5a having a first microscopic asperity shape 5 and a layer (second layer) 6 constituted of a plurality of gratings 6a having a second microscopic asperity shape. The anti-reflection structure 3 contacts with an incident medium 2. The medium 2 is air. The optical element 1 has a structure in which the anti-reflection structure 3 is added onto a surface of the transparent substrate 4 such as a lens or a parallel flat plate.

Average intervals (pitches Px and Py) of the gratings 5a and 6a having microscopic asperities are set to values of any wavelength of a working wavelength or smaller. Here, the working wavelength means, for example, a wavelength within the wavelength range of 400 to 700 nm of visible light. The pitches Px and Py of the gratings 5a and 6a are determined such that undesired diffracted light does not occur when incident light is transmitted or reflected. A layer of the first microscopic asperity shape (first layer) 5 has a structure in which a microscopic square pole gratings (microscopic portions) (microscopic asperity shapes) 5a are arranged in an orthogonal manner and in a two-dimensional manner (in the xy directions of FIG. 1). The first layer 5 is constituted of a first medium 7 and a second medium 8. A material constituting the square pole grating 5a is defined as the first medium 7. In the structure of FIG. 1, the second medium 8 is air.

As illustrated in FIGS. 2A to 2C, the square pole grating 5a has a width ax in the x direction and a width ay in the y direction. A height of the grating 5a in the first layer 5 is d1. Here, a ratio of the entire volume of the square pole grating 5a made of the first medium 7 in the volume of the first layer 5 is defined as a filling factor FF1 in the first layer 5. Similarly, the layer of the second microscopic asperity shape (second layer) 6 is constituted of a third medium 9 and a fourth medium 10, and a material constituting the square pole grating 6a is defined as the third medium 9. In the structure of FIG. 1, the fourth medium 10 is air. The square pole grating 6a has a width bx in the x direction and a width by in the y direction. A height of the grating 6a in the second layer 6 is d2. Here, a ratio of the entire volume of the square pole grating 6a made of the third medium 9 in the volume of the second layer 6 is defined as a filling factor FF2 in the second layer 6. The pitch and the arrangement of the square pole gratings 6a constituting the second layer 6 are the same as the pitch and the arrangement of the square pole gratings 5a constituting the first layer 5.

With this structure, the square pole gratings 6a constituting the second layer 6 may be formed only on the interfacial surface of the square pole grating 5a constituting the first layer 5. It is relatively easy to form the microscopic structure only on a surface of a single medium. Note that the shape of the gratings 5a and 6a may be a polygonal pole or a cylinder, instead of the square pole. The anti-reflection structure 3 of Example 1 is characterized in that a difference FF1−FF2 between the filling factor FF1 of the first layer 5 as a layer 1 and the filling factor FF2 of the second layer 6 as a layer 2 is set to be in a specific range. As described later in detail, it is preferable to set the difference FF1−FF2 of the filling factor as follows.

0.36≦FF1−FF2≦0.56 (1)

In addition, in order to provide higher performance, it is preferable to set the difference FF1−FF2 of the filling factor as follows.

0.40≦FF1−FF2≦0.48 (1a)

In this manner, reflection light generated on the interfacial surface between the first layer 5 and the second layer 6 may be effectively used, so that high anti-reflection performance may be obtained with a structure having relatively small height of the microscopic asperities region (anti-reflection structure) 3. Described above is a basic form of the optical element. In addition, the optical element of the present invention is made of a plastic resin or an ultraviolet curing resin. If there are a plurality of layers having different filling factors, the filling factor increases gradually from the incident medium toward the transparent substrate 4. Then, the microscopic asperity structure is formed on a flat surface or a curved surface.

### Example 1

A specific structure of Example 1 of the present invention is described. As described above, FIG. 1 illustrates a basic structure of the optical element of the present invention. The optical element of Example 1 includes the anti-reflection structure 3 formed on a glass substrate (transparent substrate) (substrate) 4. In Example 1, the substrate 4, the first medium 7, and the third medium 9 are made of the same medium. In addition, the incident medium 2, the third medium 8, and the fourth medium 10 are made of the same medium. Further, the incident medium 2 is air. With this structure, the anti-reflection structure 3 may be manufactured easily by molding using a mold.

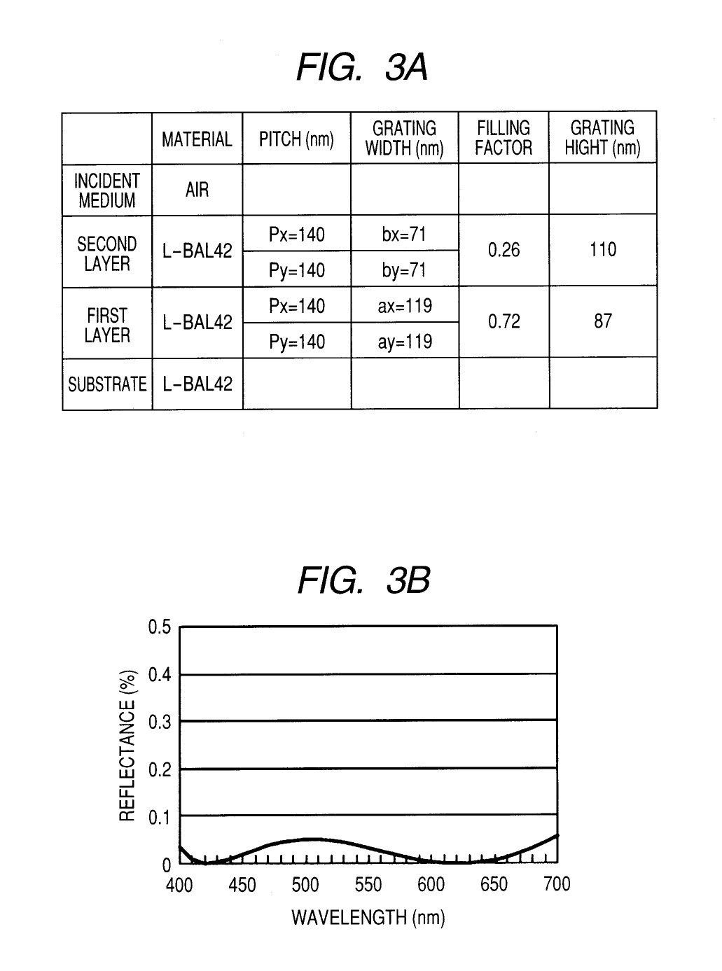

FIG. 3A is a table illustrating structural parameters of Example 1. As the substrate 4, optical glass for glass molding L-BAL42 manufactured by Ohara Corporation (refractive index nd=1.58313, Abbe's number vd=59.4) is used. In the table, the first layer represents the first layer 5 of the first microscopic asperity shape, and the second layer represents the second layer 6 of the second microscopic asperity shape. The pitch of the grating having microscopic asperities is the same between the first layer and the second layer, and is the same between the x direction and the y direction, to thereby make an orthogonal arrangement. Further, the pitches Px and Py are set to 140 nm so that undesired diffracted light does not occur.

Further, the grating 5a of the first layer 5 is a square pole which has the width ax in the x direction set to 119 nm and the width ay in the y direction set to 119 nm. The above-mentioned filling factor FF1 in this shape is as follows.

FF1=(ax×ay)/(Px×Py)=(119×119)/(140×140)=0.72

Further, the height d1 of the grating 5a of the first layer 5 is set to 87 nm. The grating 6a of the second layer 6 is a square pole which has the width bx in the x direction set to 71 nm and the width by in the y direction set to 71 nm. The filling factor FF2 in this case is similarly determined as FF2=0.26. Further, the height d2 of the grating 6a in the second layer 6 is 110 nm.

A difference between the two filling factors is determined as follows.

FF1−FF2=0.72−0.26=0.46

This satisfies the structure of the present invention. In addition, the height of the microscopic asperities region 3 is as follows.

d1+d2=87+110=197nm

This is a thin height below 200 nm. FIG. 3B is a graph illustrating a reflectance of this structure for visible light in the wavelength range from 400 to 700 nm. This characteristic is characteristic when light is made incident on the surface on which the microscopic asperities region 3 is formed from the incident medium side perpendicularly. It is understood that high anti-reflection performance of 0.05% or lower in the entire region of visible light is obtained.

In the conventional anti-reflection structure of a conical shape, the microscopic asperities portion has the height of approximately 200 nm, so that high performance anti-reflection characteristic is not obtained though anti-reflection effect exists. Therefore, the structure in which layers having different filling factors are optimally laminated like the structure of Example 1 is a structure that provides the high performance anti-reflection characteristic without increasing the height of the microscopic asperities region 3. Further, as the height of the microscopic asperities region 3 becomes lower, the manufacturing becomes easier. In particular, if the grating having microscopic asperities is manufactured by molding using a mold, the structure is preferable from a viewpoint of transferring property and releasing property. In addition, in the manufacturing method by molding, in order to facilitate separation from a mold, it is preferable that the above-mentioned layers having different filling factors are laminated so that the filling factor increases gradually from the incident medium toward the substrate.

In Example 1, anodization and hole size increasing process are repeated on the mold so that the microscopic asperity structure is added onto the surface of the mold. Here, the following methods may be used for calculation of the anti-reflection performance illustrated in FIG. 3B. One method is a method of calculating reflectance and transmittance rigorously from a viewpoint of wave optics in the microscopic structure by vector analysis such as rigorous coupled-wave analysis (RCWA). Another method is a method of calculating the microscopic asperities region as approximation to a uniform refractive index layer. This method is called an effective refractive index method and is useful in the region where the pitch of the microscopic asperity structure is sufficiently smaller than the working wavelength.

The effective refractive index method is applied to the above-mentioned example as follows. When a central wavelength of the visible light range λ0 is 550 nm, the first medium 7 of the first layer 5 has an effective refractive index n1e=1.398, and the third medium 9 of the second layer 6 has an effective refractive index n2e=1.135. In addition, the optical film thicknesses are as follows.

n1e×d1=1.398×87=121.6nm

n2e×d2=1.135×110=124.9nm

With respect to λ0/4=137.5 nm, the optical film thickness of the first layer 5 has a value of 0.88 times the value, and the optical film thickness of the second layer 6 has a value of 0.91 times the value.

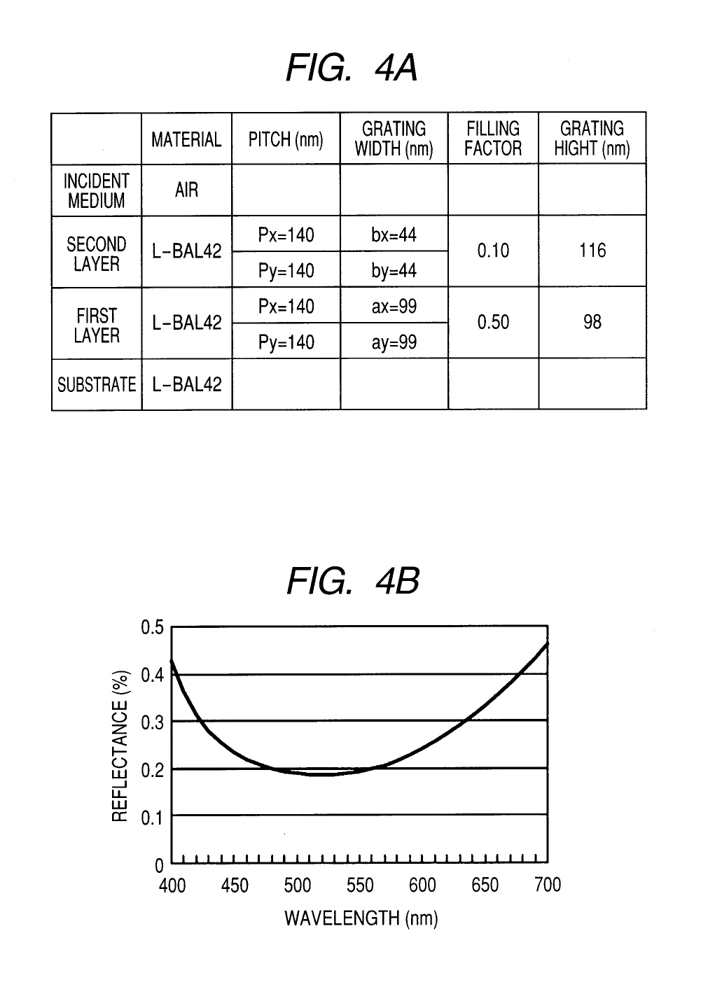

Next, the same material as in the above-mentioned example is used and the filling factor FF1 of the first layer 5 is set to 0.5. Shape parameters in this case are illustrated in FIG. 4A, and a reflectance characteristic in this case is illustrated in FIG. 4B. Compared with the above-mentioned Example 1, the anti-reflection characteristic is deteriorated, but a good characteristic of 0.5% or lower is obtained in the entire region of the visible light (in the wavelength range from 400 to 700 nm). The filling factor difference in Example 1 is as follows.

FF1−FF2=0.40

In addition, the optical film thicknesses are as follows.

n1e×d1=1.267×98=124.2nm

n2e×d2=1.051×116=121.9nm

With respect to λ0/4=137.5 nm, the optical film thickness of the first layer 5 has a value of 0.90 times the value, and the optical film thickness of the second layer 6 has a value of 0.88 times the value.

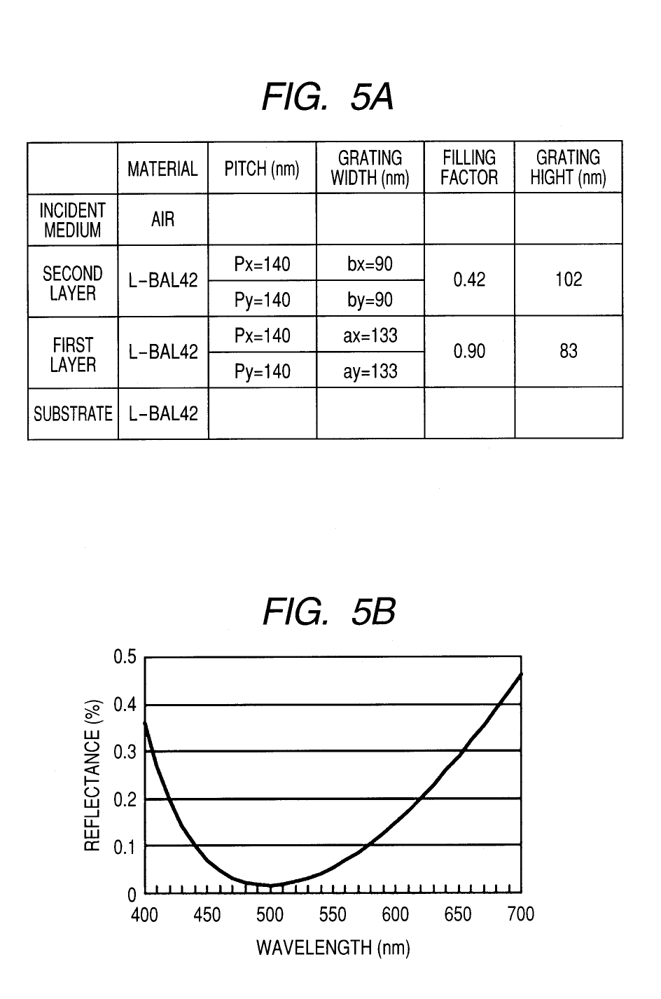

Next, the same material as the above-mentioned example is used and the filling factor FF1 of the first layer 5 is set to 0.9. Shape parameters in this case are illustrated in FIG. 5A, and a reflectance characteristic in this case is illustrated in FIG. 5B. A good characteristic of 0.5% or lower is obtained in the entire region of the visible light again. The filling factor difference in Example 1 is as follows.

FF1−FF2=0.47

In addition, the optical film thicknesses are as follows.

n1e×d1=1.515×83=125.7nm

n2e×d2=1.219×102=124.3nm

With respect to λ0/4=137.5 nm, the optical film thickness of the first layer 5 has a value of 0.91 times the value, and the optical film thickness of the second layer 6 has a value of 0.90 times the value.

Next, using the same material as in the above-mentioned example, the filling factor FF1 of the first layer 5 is set to 0.72, which is the same as the filling factor of the structure in FIGS. 3A and 3B, so as to investigate a range within which the difference of the filling factor as the feature of Example 1 should fall. A characteristic of reflectance that is 0.5% or lower in the entire region of visible light is regarded as falling within a good range, and a case of a minimum difference of filling factor and a case of a maximum difference of filling factor are determined.

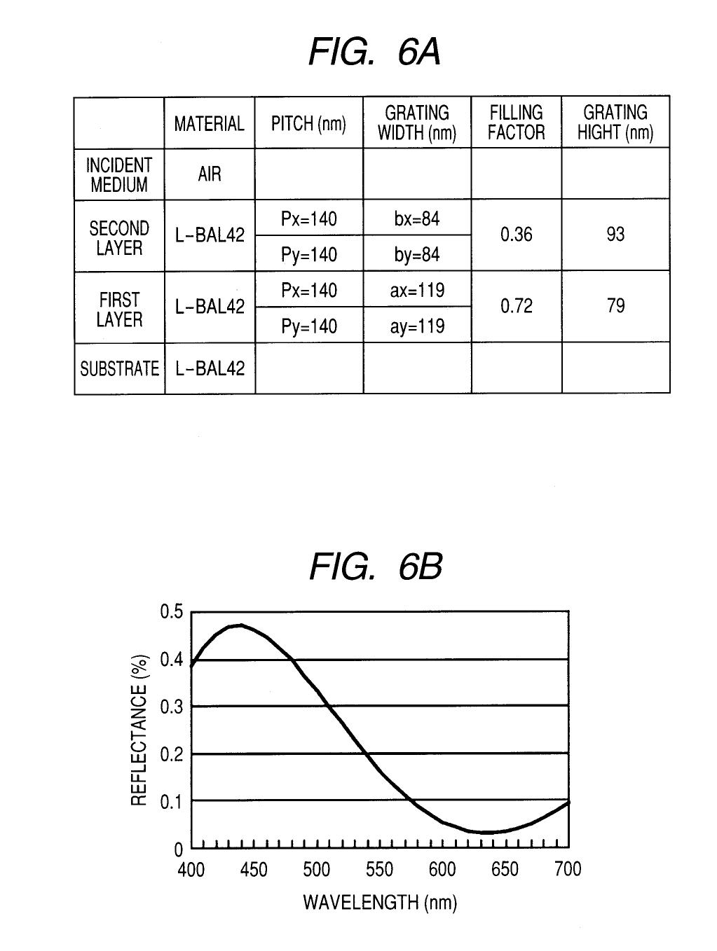

FIG. 6A is a table illustrating parameters of the structure where the filling factor difference is minimum. In this case, the filling factor difference is as follows.

FF1−FF2=0.36

In addition, the reflectance characteristic is 0.5% or lower in the entire region of visible light as illustrated in FIG. 6B. The optical film thicknesses in this example are as follows.

n1e×d1=1.398×79=110.4nm

n2e×d2=1.188×93=110.5nm

With respect to λ0/4=137.5 nm, the optical film thickness of the first layer 5 has a value of 0.80 times the value, and the optical film thickness of the second layer 6 has a value of 0.80 times the value. This example corresponds to a structure where the height of the microscopic asperities region 3 is 172 nm, which is fairly thin.

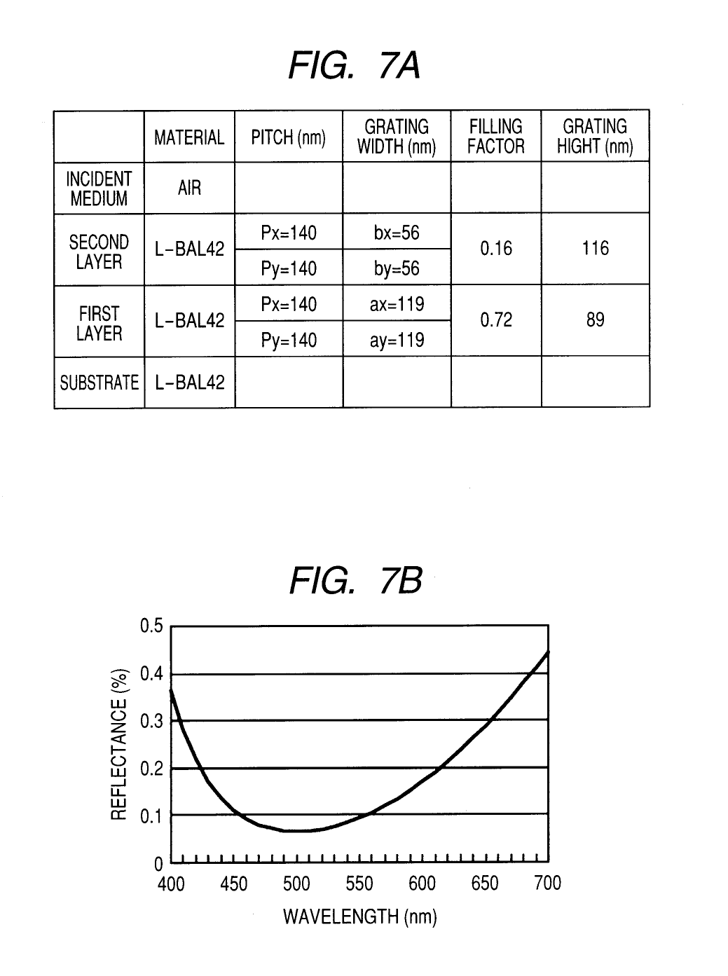

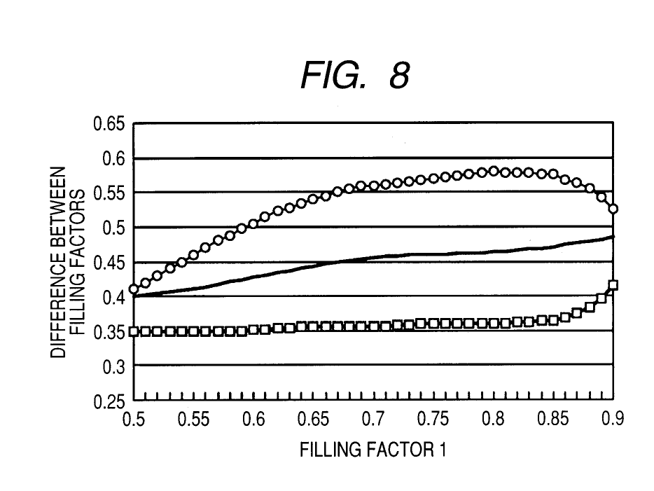

FIG. 7A is a table illustrating parameters of the structure where the filling factor difference is maximum. In this case, the filling factor difference is as follows.

FF1−FF2=0.56

In addition, the reflectance characteristic is 0.5% or lower in the entire region of visible light as illustrated in FIG. 7B. The optical film thicknesses in this example are as follows.

n1e×d1=1.398×89=124.4nm

n2e×d2=1.082×116=125.5nm

With respect to λ0/4=137.5 nm, the optical film thickness of the first layer 5 has a value of 0.90 times the value, and the optical film thickness of the second layer 6 has a value of 0.91 times the value.

Next, as illustrated in FIG. 8, the range of the filling factor difference in the case where the reflectance characteristic is 0.5% or lower in the entire region of visible light as described above is plotted. In the graph, the horizontal axis represents the filling factor in the first layer 5. The solid line in FIG. 8 indicates a relationship of the filling factor difference in which the best anti-reflection performance is obtained in each filling factor as illustrated in FIGS. 3A and 3B, 4 and 5. In addition, the region between the line of circles and the line of boxes is the range where good anti-reflection performance may be realized.

From the characteristic described above, it is understood that the difference (FF1−FF2) between the filling factor FF1 and the filling factor FF2 has high correlation even if the filling factor of the first layer 5 is changed largely. Therefore, it is understood that it is important to set the difference (FF1−FF2) between the filling factor FF1 of the first layer 5 and the filling factor FF2 of the second layer 6 to be in a specific range so that high performance anti-reflection characteristic may be obtained. Specifically, the difference (FF1−FF2) should be set as the conditional expression (1). Further, in order to obtain higher performance, the difference (FF1−FF2) should be set as the conditional expression (1a).

In addition, as to the optical film thickness, with respect to a thickness of ¼ of the central working wavelength, each of the first layer 5 and the second layer 6 has a value within the range from 0.8 to 0.91 times the value. The above-mentioned anti-reflection performance corresponds to the optical film thickness when light is made incident on the optical element perpendicularly. For instance, if the incident angle is 35 degrees, the optical film thickness becomes thinner by cos 35°=0.82. Therefore, it is necessary to increase the actual film thickness by 1/cos 35°=1.22. Therefore, considering the case of using the anti-reflection structure of Example 1 for an obliquely incident light flux, it is preferable to set the product of an apparent refractive index n1e or n2e and a thickness d1 or d2 of the microscopic asperities (grating 5 or 6) to be in the range as below.

0.8×λ0/4≦n1e×d1≦1.1×λ0/4

0.8×λ0/4≦n2e×d2≦1.1×λ0/4

where λ0 denotes the central wavelength of the working wavelength.

### Example 2

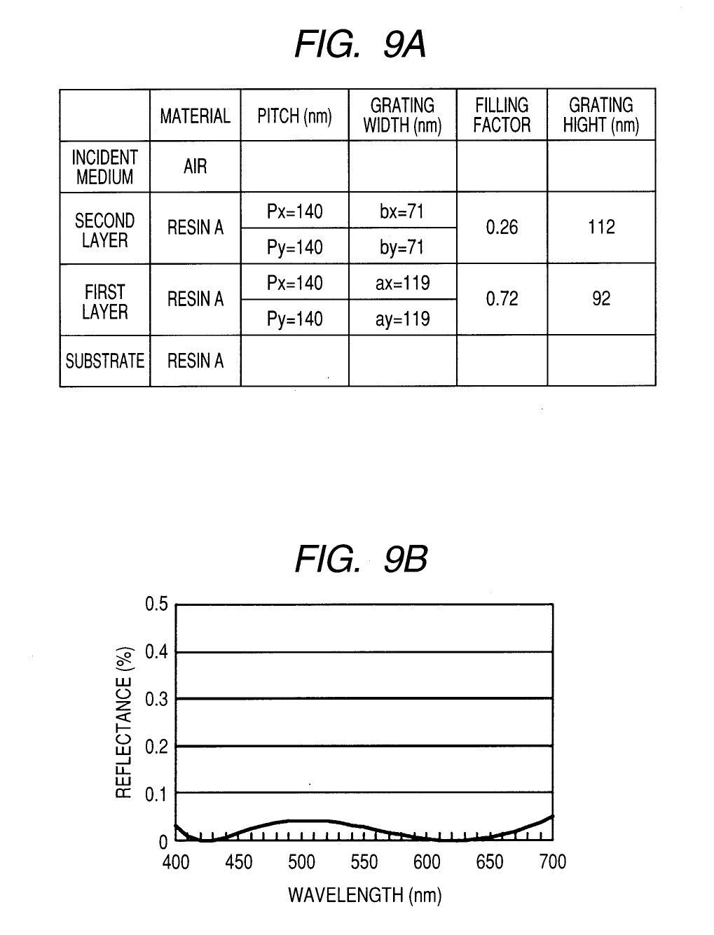

An optical element of Example 2 corresponds to a case where the material is a resin in the structure illustrated in FIG. 1. In this example too, the substrate 4, the first medium 7, and the third medium 9 are made of the same medium. FIG. 9A is a table illustrating structural parameters of Example 2. As the substrate 4, a plastic resin (nd=1.5304, vd=56.0) is used. The reflectance in the wavelength range from 400 to 700 nm of visible light in this structure is illustrated in FIG. 9B. In this case too, high anti-reflection performance of 0.05% or lower is obtained in the entire region of visible light similarly to Example 1. The filling factor difference (FF1−FF2) in this example is 0.46, which satisfies the conditional expression (1).

### Example 3

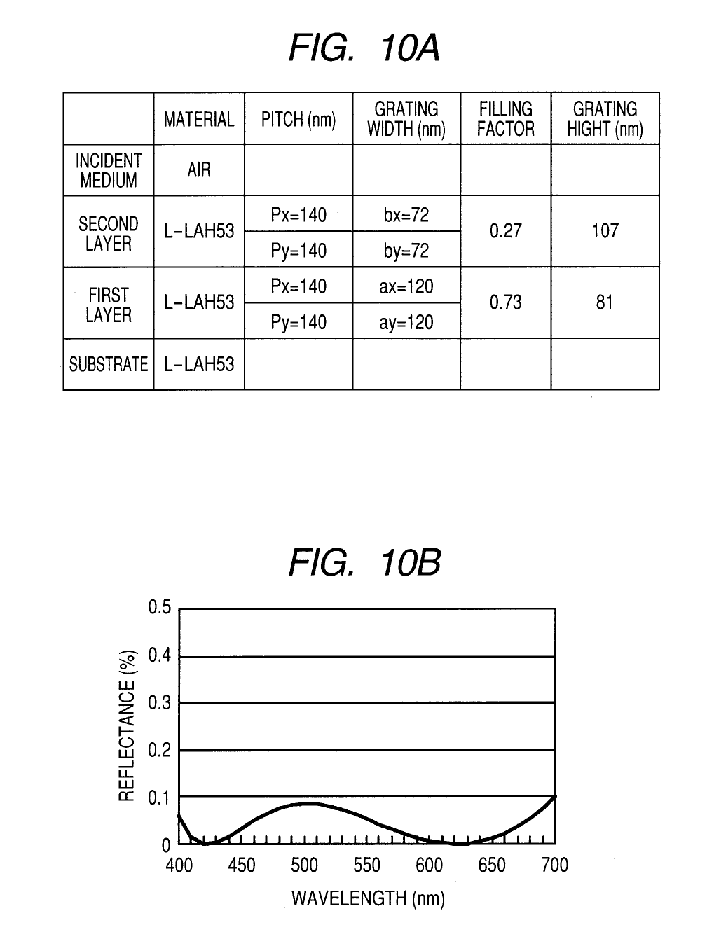

An optical element of Example 3 corresponds to a case where the material is a high refractive glass in the structure illustrated in FIG. 1. In this example too, the substrate 4, the first medium 7, and the third medium 9 are made of the same medium. FIG. 10A is a table illustrating structural parameters of Example 3. As the substrate 4, optical glass for glass molding L-LAH53 manufactured by Ohara Corporation (nd=1.80610, vd=40.9) is used. The reflectance in the wavelength range from 400 to 700 nm of visible light in this structure is illustrated in FIG. 10B. In this case, it is understood that, compared with Example 1, the anti-reflection characteristic is slightly deteriorated, but high anti-reflection performance of 0.1% or lower is obtained in the entire region of visible light. The filling factor difference (FF1−FF2) in this example is 0.46, which satisfies the conditional expression (1).

### Example 4

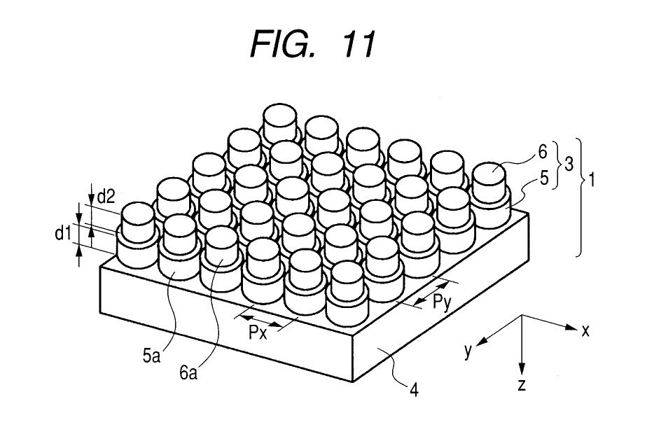

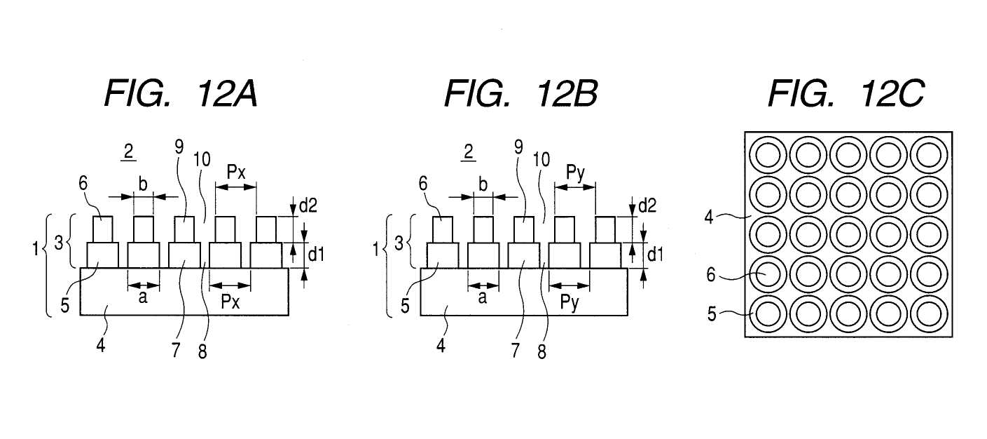

The anti-reflection structure 3 in each of the above-mentioned Examples 1 to 3 is the structure in which the gratings having the microscopic asperity structure of the square poles are laminated in two layers. The optical element of the present invention is characterized in that the filling factor difference between the two layers constituted of two microscopic asperity structures is set to be in a specific range, without depending on a shape of the grating having microscopic asperities. For instance, the grating may have the cylindrical microscopic asperity structure as illustrated in FIG. 11 and FIGS. 12A to 12C. In this case too, the filling factors of the cylindrical gratings 5a and 6a should be set to satisfy the conditional expression (1). In addition, if the gratings are arranged in the two-dimensional periodical structure, the arrangement of the gratings having microscopic asperities may also be other arrangement such as triangular arrangement besides the arrangement having pitches in the xy directions as illustrated in FIG. 11 and FIGS. 12A to 12C. In addition, the pitches in the xy directions are not necessarily the same as illustrated in FIG. 11 and FIGS. 12A to 12C. In use as the optical element, different pitches may be set among locations or between the x direction and the y direction according to a change of incident angle with respect to the optical element.

### Example 5

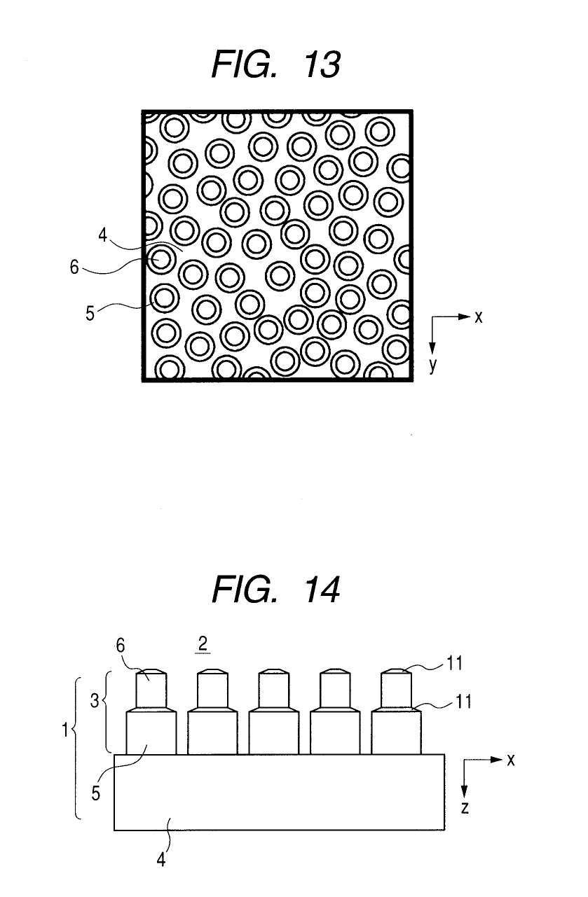

FIG. 13 is a plan view of a main part of an optical element of Example 5 of the present invention. The gratings constituted of the microscopic asperity shape may be arranged at random as illustrated in FIG. 13. In the case of the random arrangement, with respect to each grating having microscopic asperities, intervals between neighboring gratings are measured. An average of the intervals should be equal to or smaller than the working wavelength. In addition, the filling factor should be determined to be in a range that may be considered to be sufficiently random in view of the working light flux. FIG. 13 illustrates a structure in which the cylindrical gratings are arranged at random. In addition, as to the manufactured optical element, the effective refractive index and the layer thickness should be analyzed in an evaluation region that may be regarded to be sufficiently uniform by using spectral ellipsometry method or the like.

Next, as an example, a method of manufacturing such a cylindrical grating on a mold that is formed at random is described. After forming an aluminum film on the mold, an anodization process is performed so that microscopic holes are formed. The average interval may be adjusted by changing a formation voltage in the anodization. In addition, the depth of the microscopic holes may be controlled by anodization time. After that, etching or the like is performed so that the hole size is increased. Thus, a desired shape of the hole size is obtained. If this process is performed twice, cylindrical holes having different hole sizes are formed in two layers.

As a method of forming an optical element using this mold, there are generally known methods including 2P molding by using a UV curing resin, hot press molding, and injection molding of a resin. If these molding methods are used, it is easy to manufacture the optical element having a surface on which the anti-reflection structure of the microscopic asperity structure is formed. Particularly by molding a resin, in the structure having the anti-reflection structure formed on a surface of an optical element such as a lens, the anti-reflection structure may be integrally molded with the lens, which facilitates the manufacturing. In addition, in the case of using the UV curing resin, the UV curing resin is coated on the glass substrate, and the anti-reflection structure may be formed on the resin surface. In this case, the UV curing resin layer remains between the substrate and the microscopic asperity shape layer, but the high performance anti-reflection structure may be realized, considering the substrate 4 having the structure illustrated in FIG. 1 or the like as the remaining resin layer.

### Example 6

The above-mentioned example describes the two-layered structure having the microscopic asperity shape of different filling factors, for specifying the structure. An actual grating having microscopic asperities may have a shape in which edges of the microscopic asperities become rounded in the interfacial surface of each layer as illustrated in FIG. 14 when it is manufactured by molding or the like. Even with this shape, high anti-reflection performance may be realized. As illustrated in FIG. 14, rounded shape regions 11 formed in the interfacial surface between the first layer 5 and the second layer 6 may be regarded as a set of very thin layers with a filling factor varying along with a change of the grating having microscopic asperities. If the rounded region is large, the shape of the grating having microscopic asperities becomes close to a conical shape, which is not preferable. Therefore, it is preferable that the rounded region has a height that is equal to or smaller than ⅕ of the height of the first layer 5 or the second layer 6, or is equal to or smaller than 1/20 of the working wavelength.

### Example 7

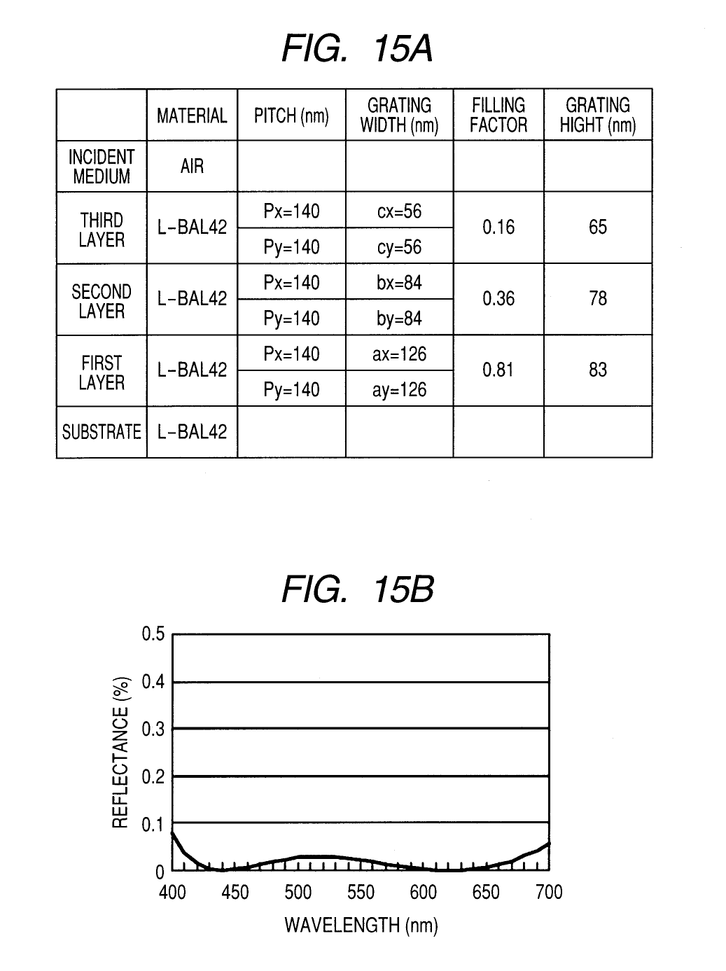

The anti-reflection structure of the above-mentioned example has a structure in which two layers having different filling factors are laminated. However, the optical element of the present invention is not limited to the two-layered structure, and is also effectively applicable to a case of the layer structure having three or more layers. FIG. 15A illustrates shape parameters in the case of the anti-reflection structure constituted of the three-layered structure. The material is the same as Example 1, which is L-BAL42 manufactured by Ohara Corporation. FIG. 15B illustrates a reflectance characteristic in this case. Even in this case, a good characteristic of 0.1% or lower is attained in the entire region of visible light. The filling factor difference in this example is as follows.

FF1−FF2=0.45

FF2−FF3=0.20

It is understood that the first layer and the second layer satisfy the conditional expression (1). If the structure of the conditional expression (1) is satisfied in either one of the layers, good anti-reflection performance may be attained. In addition, the optical film thickness is as follows.

n1e×d1=1.455×83=120.8nm

n2e×d2=1.188×78=92.7nm

n3e×d2=1.082×65=70.3nm

With respect to λ0/4=137.5 nm, the optical film thickness of the first layer has a value of 0.88 times the value, the optical film thickness of the second layer has a value of 0.67 times the value, and the optical film thickness of the third layer has a value of 0.51 times the value.

### Example 8

FIG. 16 illustrates a lens cross section of an image taking optical system (optical system) that uses the optical element of the Example 8 of the present invention. In FIG. 16, an image taking lens 12 includes an iris stop 14 and the above-mentioned optical element 1 inside. In FIG. 16, the anti-reflection structure is formed on the first lens surface of the last lens. An image forming surface 13 is a film or a CCD. The optical element 1 is a lens function element in FIG. 16, which suppresses reflection at the lens surface so as to reduce occurrence of flare light. In Example 8, the optical element having the anti-reflection structure is provided as the last lens, but this structure should not be interpreted as a limitation. The optical element having the anti-reflection structure may be provided as another lens or as a plurality of lenses. In addition, Example 8 describes the case of the image taking lens of a camera, but this structure should not be interpreted as a limitation. The optical element of the present invention may be used in an optical system that is used in a wider wavelength range, such as an image taking lens of a video camera, an image scanner of a business machine, a reader lens of a digital copying machine, a scanning optical system, a projector, or a laser optical system, so that similar anti-reflection effect may be obtained.

### Example 9

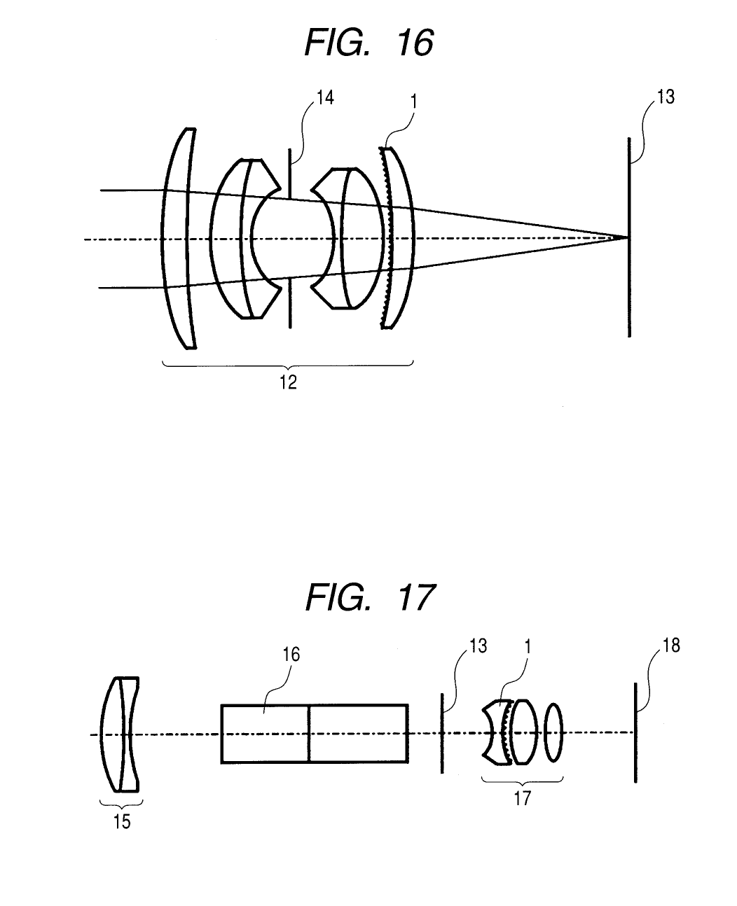

FIG. 17 illustrates a lens cross section of an observing optical system such as a binocular that uses an optical element of Example 9 of the present invention. As illustrated in FIG. 17, an objective lens 15, a prism 16 for forming an image, eyepiece lenses 17, and an evaluation surface (pupil surface) 18 are provided. An optical element 1 corresponds to the above-mentioned optical element of the present invention. In FIG. 17, one of the eyepiece lenses 17 is constituted of the optical element 1 having the anti-reflection structure of the present invention, but this structure should not be interpreted as a limitation. The optical element of the present invention may be used for another lens, or a plurality of optical elements of the present invention may also be used.

In addition, the observing optical system illustrated in FIG. 17 is the case where the optical element of the present invention 1 is used for the eyepiece lens 17, but this structure should not be interpreted as a limitation. It is possible to dispose the optical element of the present invention at a position of a surface of the prism 16 or a position in the objective lens 15, so that the same effect may be obtained. In addition, Example 9 describes the case of a binocular, but this structure should not be interpreted as a limitation. The optical element of the present invention may be applied to an observing optical system such as a terrestrial telescope or an astronomical telescope so that the same effect may be obtained. In addition, the optical element of the present invention may also be applied to an optical finder (optical system) of a lens shutter camera, a video camera, or the like, so that the same effect may be obtained.

As described above, according to Examples described above, high anti-reflection performance may be obtained without increasing too much the height of the grating of the microscopic asperity structure. Therefore, by using the present invention, it is possible to realize an optical element having high performance anti-reflection structure without increasing difficulties in molding or the like in the manufacturing process. Further, by using the optical element of each example in an optical system, it is possible to provide the optical system having good optical performance with little occurrence of undesired diffracted light or flare light.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-132941, filed Jun. 2, 2009, which is hereby incorporated by reference herein in its entirety.

What is claimed is:

1. An optical element comprising:
a transparent substrate; and
an anti-reflection structure formed on an interfacial surface between the transparent substrate and an incident medium, in which a plurality of gratings having one of a convex shape and a concave shape are arranged, wherein:
the plurality of gratings are arranged with an average interval of a wavelength equal to or smaller than a predetermined wavelength falling within a working wavelength range;
the anti-reflection structure includes a structure in which a first layer and a second layer are laminated, the first layer and the second layer having different filling factors of gratings in the arrangement surface of the gratings; and
the first layer and the second layer satisfy a conditional expression of 0.36≦FF1−FF2≦0.56 when the first layer has a filling factor FF1 of the gratings therein and the second layer has a filling factor FF2 of the gratings therein.

2. An optical element according to claim 1, wherein the filling factors of the plurality of layers having different filling factors increase gradually from the incident medium toward the transparent substrate.

3. An optical element according to claim 1, wherein the first layer and the second layer satisfy at least one of conditional expressions of:
0.8×λ0/4≦n1e×d1≦1.1×λ0/4; and
0.8×λ0/4≦n2e×d2≦1.1×λ0/4,
when the first layer and the second layer have effective indexes of n1e and n2e, and layer thicknesses of d1 and d2, respectively, and the working wavelength has a central wavelength λ0.

4. An optical element according to claim 1, wherein the anti-reflection structure is formed by molding and transferring a shape by using a mold on which an inverted shape of the grating structure of the plurality of gratings is formed.

5. An image taking optical system comprising the optical element according to claim 1.

6. An image observing optical system comprising the optical element according to claim 1.
